(19) United States
(12) Patent Application Publication
(10) Pub. No.: US 2008/0008391 A1
(43) Pub. Date: Jan. 10, 2008

(54) Method and System for Document Form Recognition

(76) Inventors: Amir Geva, Yokne'am llit (IL); Eugeniusz Walach, Haifa (IL); Aviad Zlotnick, D.N. Lower Galilee (IL)

Correspondence Address: IBM CORPORATION, T.J. WATSON RESEARCH CENTER, P.O. BOX 218, YORKTOWN HEIGHTS, NY, 10598, US

(21) Appl. No.: 11/456,247

(22) Filed: Jul. 10, 2006

(51) Int. Cl. G06K 9/34; G06F 15/00; G06K 9/68; G06K 9/62

(52) U.S. Cl. 382/224; 382/176; 382/218; 715/243

(57) ABSTRACT

A method and system for document form recognition are provided. A first instance of a document type (101) is processed to manually associate roles for each input data string with the format of the input data strings to provide predefined document types. When a subsequent instance of a document type (102) is input into the system, the format (123) of its input data strings (120) is determined and compared to the format (113) of the input data strings (110) of the manually predefined document types (115) to determine a matched document type (101). The input data strings (120) are associated with the roles (114) defined for corresponding input data strings (110) of the matched predefined document type (101).

### FIELD OF THE INVENTION

This invention relates to the area of document form recognition. In particular, the invention relates to document form recognition for processing multiple documents having equivalent strings.

### BACKGROUND OF THE INVENTION

In document processing, documents are scanned into a computer which then processes the resultant document images to extract information. Documents may take many different forms including pre-printed templates with predefined fields in which input data is filled in manually in writing or with machine-printed characters. In structured forms, a field is a location that indicates a role of the contents of the field. Other documents may be unstructured forms in which there are no fields and the input data strings are therefore in un-defined locations in the document.

In many cases of document processing in which information is extracted from multiple documents, there may be many variations of the same document type. A document type can be defined as document having the same purpose or function. Documents which are of the same document type will have equivalent strings of input data; however, they may vary in form such as the layout, graphics, language, etc. The equivalent strings of input data have the same meaning or purpose. Potentially, some of the words of equivalent strings of input data may be shared, for example, “Branch Number nn-nn-nn”, “Branch No. nn-nn-nn”, or “Branch # nn-nn-nn”. Identifying the input strings in the various forms of a document type can be time consuming and labour intensive.

A particular example is a standard letter that tells a bank to amend a standing order of paying an amount from one account to another account. Such a letter may have no special form features such as lines and boxes, but each letter takes a similar form and contains equivalent information. As such letters do not have form features, the processing of the letters to extract the required information is often labour and time intensive as the information must be located and its category identified manually. The effort to teach a system each variation of a document type is unaffordable.

One known solution to this problem is disclosed in U.S. Pat. No. 6,778,703 which describes form recognition based on matching a new document image to all the images of previously processed images. This solution is slow if there are many images to match, and it may fail if the amount of constant data in the form is small with respect to the amount of variable data (such as the account details).

Another known solution for unstructured documents, is to manually identify text clues which are used to find the input data strings. This is sometimes more effective than using form template images; however, it is very labour intensive as it is a manual process.

Some forms have distinctive and recognisable input data strings. For example, some banking forms in the UK have fields for two account numbers, one or two dates, and one or two money amounts. Known unstructured OCR (optical character recognition) packages can find and recognize these strings, but may have a difficulty in deciding field roles. For example, two strings may be recognised as account numbers but it is difficult to determine which account number is the payer and which is the payee.

### SUMMARY OF THE INVENTION

It is an aim of the present invention to provide a method and system which after manually processing one instance of a document type, obtains enough information to process subsequent instances of the document type automatically.

According to a first aspect of the present invention there is provided a method for document form recognition, comprising: processing an instance of a document type, including: determining the format of at least one input data string; comparing the format of the at least one input data string to predefined document types to determine a matched document type; associating the input data strings with roles defined for corresponding input data strings of the matched document type.

The format of the at least one input data string preferably includes the data format of the string contents. For example, data format may be the arrangement of digits of the string contents. The semantic of the string contents may be determined from the data format. For example, the digit arrangement may indicate that the data contents is a date, or an account number, etc. The string contents may be compared to possible string contents to determine the semantic of the string contents. For example, the digits of an arrangement that may be a date can be compared to the possible date ranges to confirm this. If the arrangements of digits suggests an account number, the number can be compared to a database of account numbers to confirm this.

The types of data input strings in a document instance determined by the format can be used to identify the function and therefore the type of document. For example, the number of account numbers, the number of dates, etc. in a document instance can map to a document type.

The string contents may be extracted using an unstructured optical character recognition tool. The method may include processing the string contents according to the associated role.

According to a second aspect of the present invention there is provided a computer program product stored on a computer readable storage medium, comprising computer readable program code means for performing the steps of: processing an instance of a document type, including: determining the format of at least one input data string; comparing the format of the at least one input data string to predefined document types to determine a matched document type; associating the input data strings with roles defined for corresponding input data strings of the matched document type. The computer program product may include the step of processing the input data strings' contents in accordance with the associated roles.

According to a third aspect of the present invention there is provided a system for document form recognition comprising: an extractor for extracting input data from at least one input data string of a document instance; means for determining the format of input data; a storage means storing predefined document types having roles associated with input data strings of the predefined document types; a comparator for comparing the format of the input data with the stored predefined document types.

According to a fourth aspect of the present invention there is provided a method for document form recognition provided as a service to a customer over a network, the service comprising the above method steps of the first aspect of the present invention.

The difference between this approach and the state of the art is that the state of the art matches documents by their contents. Accordingly, the matching is done only on the fixed part of the document. A key of the described method and system is to use the format of the filled in data to associate a document with its model. This can also enable automatic processing of documents that differ in their language or graphical presentation.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a schematic representation of input documents in accordance with the present invention;

FIG. 2 is a block diagram of a computer system in which the present invention may be implemented;

FIG. 3 is a block diagram of a data processing system in accordance with the present invention;

FIGS. 4A and 4B are flow diagrams of method of operation in accordance with the present invention;

FIG. 5 is a representation of an input document in accordance with the present invention; and

FIG. 6 is a representation of a graphical user interface in accordance with the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The described method and system use recognized strings from a manually processed document as features and associates subsequently input documents with the previously processed one using these features. Associating a subsequent document with a previously processed document ensures that a feature is recognised as a correct string and resolves the issue of string semantics. The advantage of using such a solution is both in speeding up document processing and in requiring less training for document processing operators.

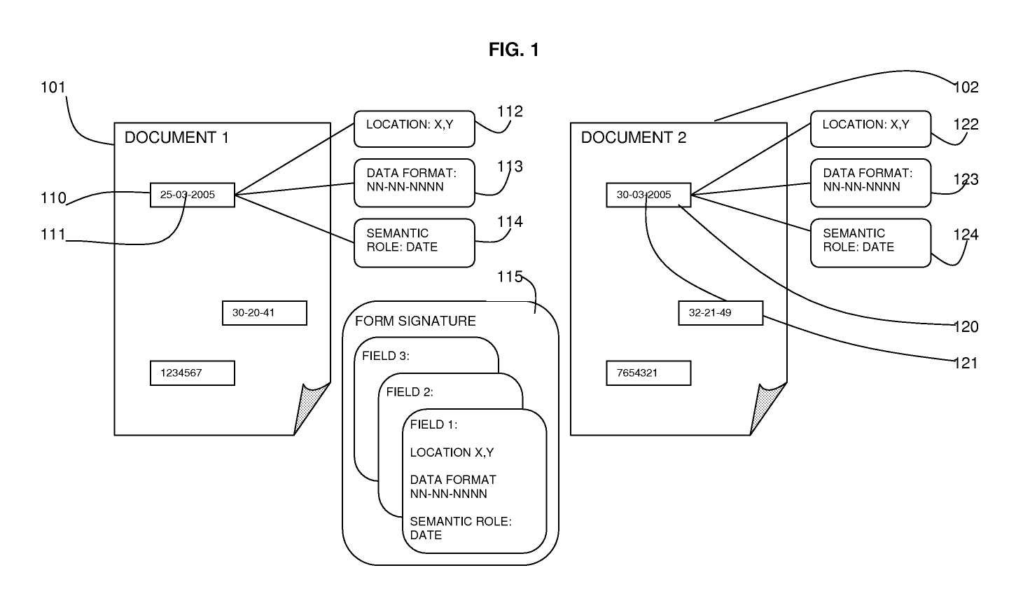

FIG. 1 shows a first document instance 101 of a document type to be processed manually and a subsequent document instance 102 of the document type to be processed automatically using the described method and system.

The first document 101 is input by an input means resulting in a display of the document 101 to a user. The document 101 may take various different forms but is generally a document 101 including at least one string 110 which has a contents 111 which is to be extracted from the document instance 101.

The string 110 has a content data format 113. For example, the content data format 113 may be a n-digit number, a number with breaks or hyphens, a date format, etc. The content data format 113 may indicate the semantic of the string 110. The term “semantic” is used to refer to what is represented by the data format 113. This is best explained by an example. A string may have a contents “09-12-2005”, this has a data format which is nn/nn/nnnn, and a semantic which is a date. However, a date may relate to many different events and the usage of the semantic in a particular context is defined as the “role” of the string, for example, a start date, an end date, a date of birth, etc.

The string 110 has a location 112 within the document 101. The location 112 may be defined by various methods, for example, by x, y measurement coordinates within the document 101, by means of a template for placing over the document 101 to identify a location, or any other means of identifying a location within the document 101. The location defining method may be independent of the displayed size or orientation of the document 101 on the system. The location 112 may be used to distinguish between different instances of the same data format of strings or same semantics of strings. It may also be used to compare string positions between document instances 101, 102.

In two instances 101, 102 of the same document type, the strings 110, 120 may match in the features of the data format 113, 123, the approximate location 112, 122, and the semantic role 114, 124. However, the contents 111, 121 of a string 110, 120 may differ for different instances 101, 102 of the same document type.

A first instance 101 of a document type is input into the processing mechanism which extracts the contents 111 of the strings (for example, by a OCR mechanism) and determines the data format of the contents 113 of the strings. The location 112 is generated for each string 110. A form signature is created 115 which defines the format 113 and location 112 of the strings 110 for this document type. An operator manually associates each string 110 with the semantic role 114 in the form signature 115 which is then stored for the document type. The string 110 contents 111 is processed in accordance with the semantic role 114.

In an alternative embodiment, the location 112, 122 of a string 110, 120 may be different in different instances of a document type and the semantic role 114 may be associated with just the format 113, 123 of the string, including any semantics included in the contents 111.

When a subsequent document instance 102 is input, the processing mechanism extracts for each string 120, the format 123 and, optionally, the location 122 and matches these to stored form signatures 115. If a match is found, the string semantic role 124 for each string 120 can be determined from the semantic role 114 of the strings 110 of the stored form signature 115. The contents 121 of each string 120 of the subsequent instance 102 of the document type is read and the string contents 121 are processed automatically according to the roles.

If a match is not made to a stored form signature 115, the operator is prompted to manually input the string semantic roles 124 and a new form signature 115 is generated and stored.

In this way, document instances 101, 102 of the same document type which differ in the language or graphical representation, can be processed by recognising the format of the types of strings and mapping them to a document type. The roles of the strings are input for a first instance of a document type and are thereafter automatically applied once the document type has been determined by the string format.

The described method is especially beneficial when processing document instances that have an almost identical string layout but different text and graphics rendering or text in different languages.

The location of strings can be used to define the strings in the form signature for a document type in addition to the strings data format and semantics. The location of strings is also used to distinguish between two strings in a document instance which have the same semantic.

An algorithm to calculate the geometric match between string locations 112, 122 can be derived from geometric hashing (Haim J. Wolfson and Isidore Rigoutsos, “Geometric Hashing: An Overview”, IEEE Computational Science & Engineering, October-December 1997, pp. 10-21). Alternatively, the algorithm used in U.S. Pat. No. 6,778,703 may be used.

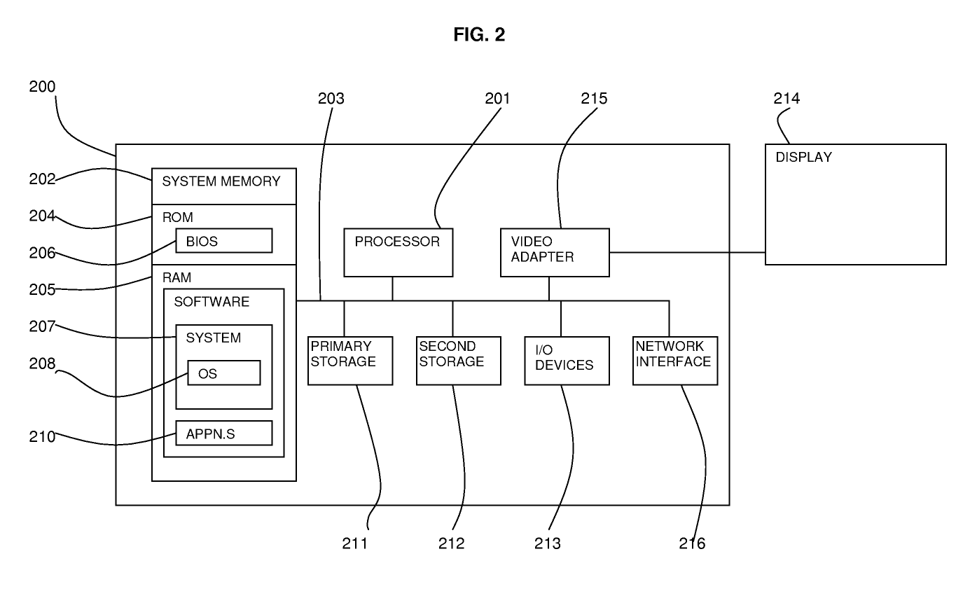

Referring to FIG. 2, an exemplary system for implementing the invention includes a data processing system 200 suitable for storing and/or executing program code including at least one processor 201 coupled directly or indirectly to memory elements through a bus system 203. The memory elements can include local memory employed during actual execution of the program code, bulk storage, and cache memories which provide temporary storage of at least some program code in order to reduce the number of times code must be retrieved from bulk storage during execution.

The memory elements may include system memory 202 in the form of read only memory (ROM) 204 and random access memory (RAM) 205. A basic input/output system (BIOS) 206 may be stored in ROM 204. System software 207 may be stored in RAM 205 including operating system software 208. Software applications 210 may also be stored in RAM 205.

The system 200 may also include a primary storage means 211 such as a magnetic hard disk drive and secondary storage means 212 such as a magnetic disc drive and an optical disc drive. The drives and their associated computer-readable media provide non-volatile storage of computer-executable instructions, data structures, program modules and other data for the system 200. Software applications may be stored on the primary and secondary storage means 211, 212 as well as the system memory 202.

The computing system 200 may operate in a networked environment using logical connections to one or more remote computers via a network adapter 216.

Input/output devices 213 can be coupled to the system either directly or through intervening J/O controllers. A user may enter commands and information into the system 200 through input devices such as a keyboard, pointing device, or other input devices (for example, microphone, joy stick, game pad, satellite dish, scanner, or the like). Output devices may include speakers, printers, etc. A display device 214 is also connected to system bus 203 via an interface, such as video adapter 215.

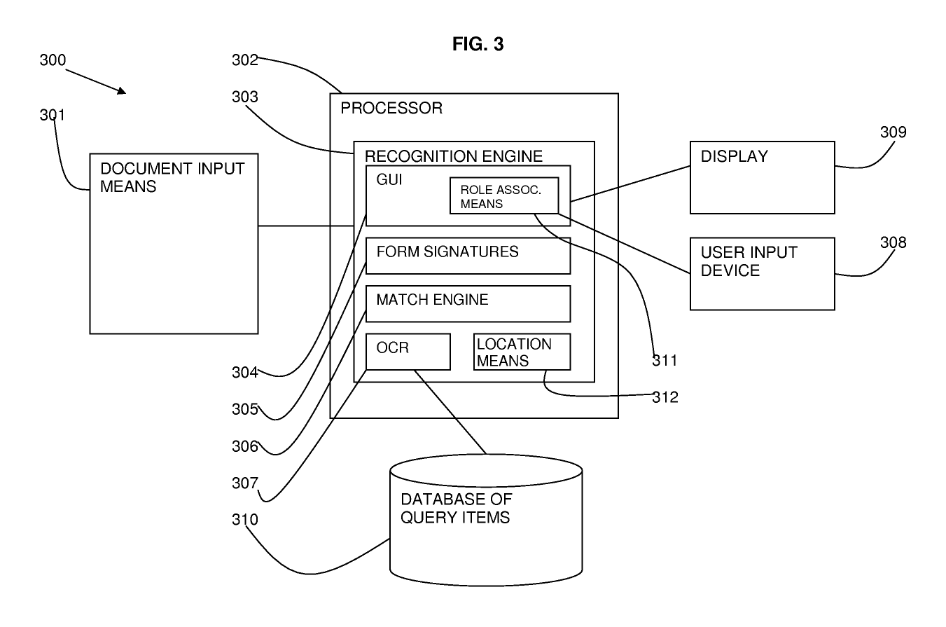

Referring to FIG. 3, a block diagram shows a more detailed data processing system 300 suitable for implementing the described method and system of form recognition. The system 300 includes a document input means 301 for inputting a document to be processed. The document input means 301 may take many different forms and includes any mechanism by which an electronic representation of a document is received on the system 300. For example, a paper document may be input into a system by a scanner or a camera, a document may be sent by a facsimile transmission and received on the system, an email messaging system may receive a document as an attachment to a message, etc.

The document input means 301 may be remote from the processing components of the system 300, as the electronic representation of the document may be created at a remote location (for example, at a scanner in one geographic location) and transferred via a network to a processing location (for example, in a second geographic location).

The system 300 includes a processor 302 having a form recognition engine 303 including a graphical user interface (GUI) 304 including input means for role association 311 with a string. The form recognition engine 303 also includes a form signature store 305 and a matching engine 306 for matching formats of strings with form signatures for document types. The form recognition engine 303 also includes an optical character recognition means 307 for extracting the contents of the strings and a location determining means 312 for determining the location of a string in a document instance. An user input device 308 is used to interact with the GUI 304 of the recognition engine 303. For example, the user input device 308 may be a keyboard, mouse, touchpad, etc. A display 309 is provided for viewing the document and the GUI 304 of the recognition engine 303.

The system 300 may also include a database 310 of query items. The database 310 may be local to the recognition engine 303 or may be provided remotely via a network. The database 310 may be provided to obtain information relating to the string contents. For example, in the embodiment of a bank processing form, a database 310 may be provided for querying items such as bank account numbers, names, IDs, addresses, etc. in the database 310.

In order to initiate a system, form signatures for different document types must be generated. This can be carried out by an operator by creating form signatures for each type of document to be processed. The form signatures may all be created at the outset, or as a first instance of each new type of document is input.

A form signature is generated by an operator manually associating a role to each string of input data in a document instance. There are many different ways in which the association may be implemented.

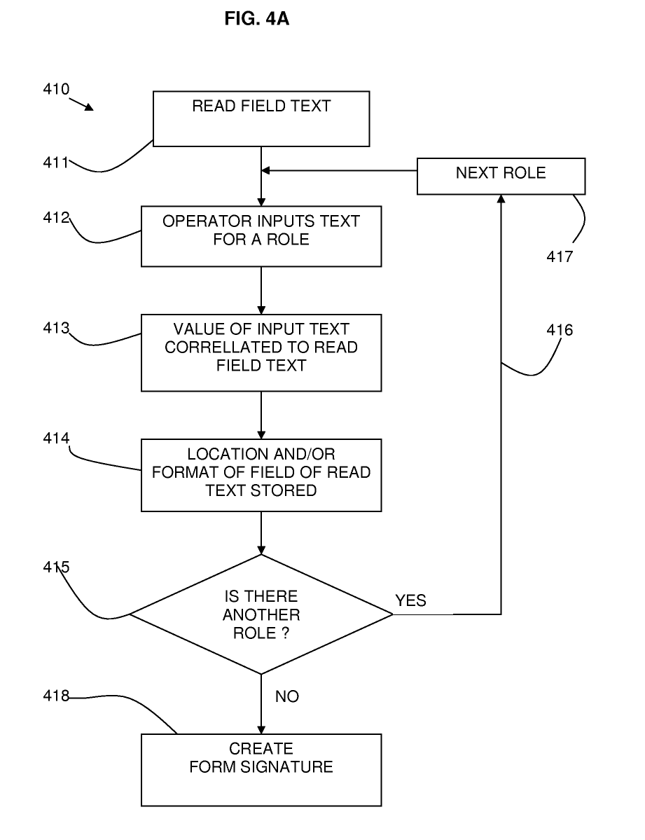

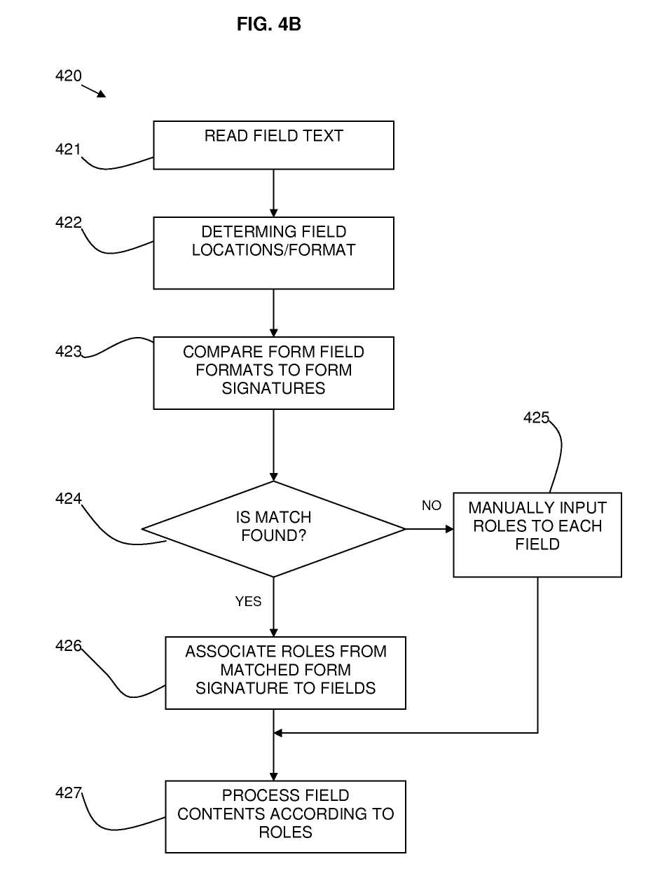

An example implementation is described in the flow diagram 410 of FIG. 4A. As a first step 411, the string text of a document instance is read by software. Database strings are provided for different roles which the strings may represent. The operator keys 412 into a database string for a role, the correct contents of the document instance for that role. The value of the keyed-in contents is correlated 413 with the string with this contents read by the software. The location and/or data format of the string is stored 414 with the role of the database string. The method may only correlate the location with the role for each string, or it may use the data format and semantic of the contents of the string.

It is then determined 415, if there is a next role. If so, the method loops 416 and the next role 417 is processed. If there is not a next role, a form signature is created and stored 418 containing all the roles with the corresponding location and/or data format of the strings.

An alternative method of associating roles with the strings includes the operator pointing at the string with a pointing device such as a mouse and dragging the contents to a database string for a role. In another embodiment, a role description may be selected from a drop down menu and then the string selected. It will be apparent to a person skilled in the art that there are many alternative ways of implementing the method.

Referring to FIG. 4B, a flow diagram 420 shows the method of processing subsequent instances of a document type. As a first step 421, the string text of a document instance is read by software. The data format and/or location are determined 422 for each of the strings. The data format and/or location of the strings is compared 423 to form signatures for different document types.

It is determined 424 if there is a match. If there is no match, the string roles are input manually 425 and the string contents processed 427. If there is a match, the roles defined in the matched form signature are associated with the strings 426 and the string contents are processed according to the associated roles 427.

A first example of the application of the described method and system is provided in which a document type is a standing order (SO) form instructing a bank to transfer an amount of money from one account to another at a certain date each month. Optionally, the form may also specify a first transfer of a different amount on a different date.

Each string has the features:

a location,

a data format—In this embodiment, the data format may include: an eight digit account number, a six digit sort code, a date, an amount with two decimal places, etc.

a semantic role—In this embodiment, the semantic role may include: the payer's account number and sort code, the payee's account number and sort code, the date and amount of the first transfer, the date each month and the amount of subsequent transfers, etc.

a content.

The strings in two instances of the same SO form should match in all their features but the content.

A SO form is scanned. An unstructured OCR mechanism finds the payee and payer account numbers, the dates, and the transfer amounts. An operator manually associates each string with its semantic role, either by pointing at the string with a pointing device such as a mouse, or manually by keying in the string contents combined with automated content matching that detects which string recognised by the OCR mechanism matches each manual entry.

All the required information from the form is now captured, and a form signature consisting of string formats, string semantics and string locations is associated with the form type.

The next time a form of this type is scanned, the string formats and locations are computed by the OCR mechanism, and these formats and locations are compared to the form signatures of previously processed forms. If a match is found then the string role semantics from the matching signature are associated with the newly scanned form, and no manual intervention is needed.

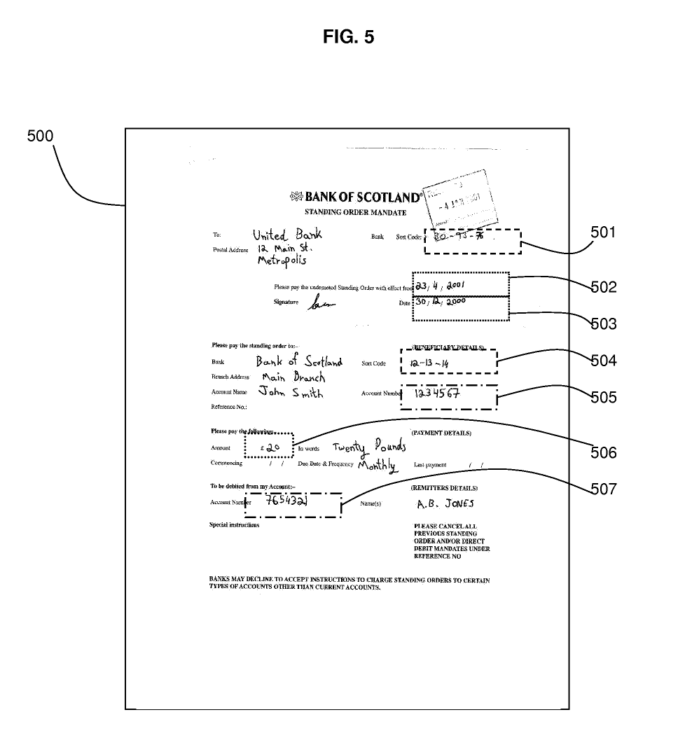

FIG. 5 shows a SO bank form 500. Hashed boxes 501-507 show the strings which have content to be extracted from the form 500. The string contents can be read by OCR software and would result in the following contents:

30-93-76

23/4/2001

30/12/2000

12-13-14

1234567

20

7654321

The data format is recognised as the following with the associated locations of the strings:

| | | |
|---|---|---|
| nn-nn-nn | location 1 | (501) |
| nn/n/nnnn | location 2 | (502) |
| nn/nn/nnnn | location 3 | (503) |
| nn-nn-nn | location 4 | (504) |
| nnnnnnn | location 5 | (505) |
| nn | location 6 | (506) |
| nnnnnnn | location 7 | (507) |

Strings 501 and 502 have the data format nn-nn-nn. This format could be a date; however, if the content digits are compared to possible dates, it will be seen that the digits are not dates. For example, taking “30-93-76” the first two digits may be the day or the month but it is not possible to have a “30” and a “93” as the day and month. This data format could be an account sort code. The content digits can be compared to a sort code database and it can be determined that they match a possible sort code.

These semantic checks can be carried out for as many strings as possible narrowing down the possible semantics of the strings, as follows:

| | |
|---|---|
| location 1 | sort code |
| location 2 | date |
| location 3 | date |
| location 4 | sort code |
| location 5 | account number |
| location 6 | amount |
| location 7 | account number |

The above summary of the strings can be compared to previously created form signatures to recognise the type of document. The form signature will have the above information with the associated roles, as follows

| | | |
|---|---|---|
| location 1 | sort code | payer sort code |
| location 2 | date | start date |
| location 3 | date | form date |
| location 4 | sort code | payee sort code |
| location 5 | account number | payee account number |
| location 6 | amount | amount |
| location 7 | account number | payer account number |

Once the form signature is matched, the string contents can be processed according to the associated roles.

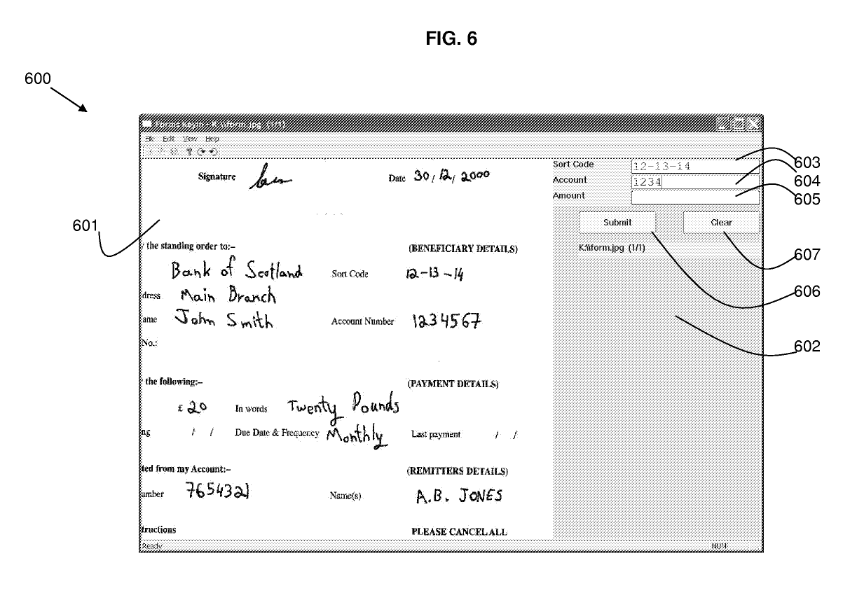

FIG. 6 shows an example graphical user interface (GUI) 600 for the manual input of roles associated with strings in order to create the form signatures. The GUI 600 displays the input document instance 601. A panel 602 contains database fields 603, 604, 605 for different roles. In this example, database field 603 is for a sort code, database field 604 is for an account number, and database field 605 is for an amount.

An operator can input manually the content digits of a database field. For example, input “12-13-14” in the database field 603 for the sort code. The corresponding string contents is located in the document instance 601 and the location stored in association with the role of sort code. Input buttons 606, 607 are provided to submit 606 or clear 607 the database fields once the contents has been entered.

In another example application of the described method and system, documents in multiple languages may be processed. This is particularly useful in countries in which there is more than one national language. For example, English and French in Canada, German, Italian and French in Switzerland, Hebrew and Arabic in Israel, etc. The described method and system enable the contents of a string to be extracted and identified without the extra effort needed to identify text adjacent to the string contents that is to be extracted.

The described method and system also avoid extra work if the language used in a GUI for manual operations is different to the language in the document. This may be of particular importance for offshore outsourcing. The GUI panels need only be defined and separate keywords found in the document itself do not need to be defined separately. In all such cases after an operator processes one (or another small number) of documents manually, the rest of the documents can be processed automatically.

A document form recognition engine may be provided as a service to a customer over a network.

The invention can take the form of an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

Improvements and modifications can be made to the foregoing without departing from the scope of the present invention.

We claim:

1. A method for document form recognition, comprising:
processing an instance of a document type, including:
determining the format of at least one input data string;
comparing the format of the at least one input data string to predefined document types to determine a matched document type;
associating the input data strings with roles defined for corresponding input data strings of the matched document type.

2. The method as claimed in claim 1, including processing the input data strings' contents in accordance with the associated roles.

3. The method as claimed in claim 1, wherein the format of the at least one input data string includes the data format of the string contents.

4. The method as claimed in claim 3, wherein the semantic of the string contents is determined from the data format.

5. The method as claimed in claim 4, wherein the string contents is compared to possible string contents to determine the semantic of the string contents.

6. The method as claimed in claim 1, wherein the string contents is extracted using an unstructured optical character recognition tool.

7. The method as claimed in claim 1, including:
determining the location of an input data string in the document instance;
distinguishing an input data string by its location.

8. The method as claimed in claim 1, including:
processing a first instance of a document type, including:
determining the format of at least one input data string;
manually defining a role for each input data string; and
storing a predefined document type with defined roles for input data strings.

9. The method as claimed in claim 8, the processing includes:
determining the location of an input data string in the document instance;
storing the approximate locations of the input data strings in the predefined document type.

10. The method as claimed in claim 9, wherein the step of comparing the format of the at least one input data string to predefined document types to determine a matched document type includes comparing the locations of the input data strings with the approximate locations in the predefined document types.

11. The method as claimed in claim 9, wherein the step of associating the input data strings with roles, associates the input data strings with roles defined for input data strings of the matched document type corresponding in approximate location.

12. A computer program product stored on a computer readable storage medium, comprising computer readable program code means for performing the steps of:
processing an instance of a document type, including:
determining the format of at least one input data string;
comparing the format of the at least one input data string to predefined document types to determine a matched document type;
associating the input data strings with roles defined for corresponding input data strings of the matched document type.

13. The computer program product as claimed in claim 12, including the step of:
processing the input data strings' contents in accordance with the associated roles.

14. A system for document form recognition comprising:
an extractor for extracting input data from at least one input data string of a document instance;
means for determining the format of input data;
a storage means storing predefined document types having roles associated with input data strings of the predefined document types;
a comparator for comparing the format of the input data with the stored predefined document types.

15. The system as claimed in claim 14, including a processor for processing the extracted input data in accordance with an associated role.

16. The system as claimed in claim 14, wherein the extractor is an unstructured optical character recognition tool.

17. The system as claimed in claim 14, including location determining means for determining the location of an input data string in a document instance.

18. The system as claimed in claim 14, including a graphical user interface for user input to predefine document types including associating roles with input data strings of the predefined document types.

19. The system as claimed in claim 14, including a database of content items to compare to extracted string content.

20. A method for providing a service for document form recognition to a customer over a network, said service comprising:
processing an instance of a document type, including:
determining the format of at least one input data string;
comparing the format of the at least one input data string to predefined document types to determine a matched document type;
associating the input data strings with roles defined for corresponding input data strings of the matched document type.
